(19) United States
(12) Patent Application Publication
(10) Pub. No.: US 2011/0187701 A1
(43) Pub. Date: Aug. 4, 2011

(54) 3D Projection System with Non-Integer Flash Rate

(75) Inventor: William Gibbens Redmann, Glendale, CA (US)

(73) Assignee: THOMSON LICENSING, Boulogne-Billancourt (FR)

(21) Appl. No.: 12/452,383

(22) PCT Filed: Jun. 27, 2007
(86) PCT No.: PCT/US2007/149630

§ 371 Date: Dec. 28, 2009

(51) Int. Cl. G06T 15/00

(52) U.S. Cl. 345/419

(57) ABSTRACT

A method of displaying a 3D image having the steps of providing a first left eye image (406) and a first right eye image (416) for display and alternately displaying the first left eye image (406) and the first right eye image (416), wherein the first left eye image and first right eye image are displayed for an unequal number of times.

### FIELD OF THE INVENTION

The invention relates to a projection system. In particular, the invention relates to a three dimensional (3D) projection system.

### BACKGROUND OF THE INVENTION

It is well known that a projected image may be enhanced with an appearance of depth by converting the projected image into a so-called three dimensional (3D) image. This is generally accomplished by optically polarizing the images which are to be viewed by a viewer's left eye differently than the images which are to be viewed by a viewer's right eye. The 3D effect is perceived by the viewer when the viewer views the polarized images through the use of polarized filter lenses, commonly configured as ‘3D viewing glasses’ with a polarized filter for use with the left eye of the viewer and a differently polarized filter for use with the right eye of the viewer. When the 3D viewing glasses are used to view the 3D images, the left eye of the viewer sees only the light polarized appropriately for passage through the polarized filter associated with the left eye and the right eye of the viewer sees only the light polarized appropriately for passage through the polarized filter associated with the right eye of the viewer. The above described method of displaying 3D images is known as passive 3D viewing where the projector alternates the left eye information with the right eye information at double the typical frame rate and a screen/filter/polarizing blocker in front of the projector's lenses alternates the polarization of the projected image in such a way that the image of each eye passes through the corresponding polarizing filter of the pair of passive stereo glasses discussed above. An alternative to passive 3D viewing is active 3D viewing where each viewer wears glasses with LCD light shutters which work in synchronization with the projector so that when the projector displays the left eye image, the right eye shutter of the active stereo eyewear is closed, and vice versa.

One problem with current systems for providing 3D images is a perceived “flicker” that is reported by some viewers of 3D images. Most generally, flicker is related to the human optical system perceiving an absence of viewable image for a first eye for the entire period the second eye is allowed to view an image. As time progresses, the second eye is prevented from viewing an image while the first eye views an image. The eyes are serially and alternatingly allowed to view images. Of course, the images viewed by the first and second eyes are of differing polarizations as described previously.

Prior Art FIG. 1 illustrates the timing of images shown to a viewer's left and right eyes using conventional systems for providing 3D images. Arrow 100 indicates a direction in which time is represented as increasing. Horizontal line 102 represents a time at which a first left eye image (hereinafter, “left eye image” is referred to as “LEI”) must be ready for projection to a viewer's left eye. LEI time period 104 (hereinafter, “LEI time period” is referred to as “LEITP”) represents the timing and duration of transfer of the first LEI (or first left eye frame) from an image generator (or image server) to a projector. Horizontal line 106 represents a time at which a second LEI must be ready for viewing by a viewer's left eye and LEITP 108 represents the timing and duration of transfer of the second LEI. Similarly, horizontal line 110 represents a time at which a third LEI must be ready for viewing by a viewer's left eye and LEITP 112 represents the timing and duration of transfer of the third LEI. In a conventional system for providing 3D images, delivery and availability for viewing of the LEIs and right eye images (hereinafter, “right eye image” is referred to as “REI”) are substantially synchronous such that they arrive to the projector from the generator and are available for projection at substantially the same time. This synchronized delivery is represented by first, second, and third REI time periods 114, 116, and 118, respectively, (hereinafter, “REI time period” is referred to as “REITP”) having substantially synchronized start and completion times to the start and completion times of LEITPs 104, 108, and 112, respectively. The gap in time between completion of delivery of the LEI and REI is generally referred to as slack in delivery 120 and typically corresponds to the time occupied by the projector actually making the images viewable.

The simplest conventional 3D image systems are single flash systems that alternate between a first LEI and first REI only once before progressing to the display of a second LEI and subsequent second REI. The timing of a single flash system 122 is represented by showing that a first LEI is flashed for a first LEI first duration 124 and followed by a first REI that is flashed for a first REI first duration 128. Next, a second LEI is flashed for a second LEI first duration 130 followed by a second REI being flashed for a second REI first duration 132. Finally, a third LEI is flashed for a third LEI first duration 134 followed by a third REI being flashed for a third REI first duration 136. As shown, a switching interval 126 occurs, where no image is shown to either eye, while switching between LEIs and REIs. However, this single flash system presents undesirable flicker.

To address the problem of flicker, double flash systems which alternate between LEIs and REIs twice before progressing to a second set of LEIs and REIs have been developed. The timing of a double flash system 138 is represented by showing that a first LEI is flashed for a first LEI first duration 140 followed by a first REI that is flashed for a first REI first duration 142. Next, the first LEI is again flashed for a first LEI second duration 144 followed by the first REI again being flashed for a first REI second duration 146. Next, a second LEI is flashed for a second LEI first duration 148 followed by a second REI being flashed for a second REI first duration 150. Next, the second LEI is again flashed for a second LEI second duration 152 followed by the second REI again being flashed for a second REI second duration 154. Next, a third LEI is flashed for a third LEI first duration 156 followed by a third REI being flashed for a third REI first duration 158. Finally, the third LEI is again flashed for a third LEI second duration 160 followed by the third REI being flashed for a third REI second duration 162. While the double flash system 138 is an improvement over the single flash system 122, this double flash system 138 still presents undesirable flicker perceived by some viewers.

A further attempt to reduce flicker has been made by providing a triple flash system that alternates three times between LEIs and REIs before progressing to subsequent sets of LEIs and REIs. The timing of a triple flash system 164 is represented by showing that images are flashed in the following order: first LEI first flash 166, first REI first flash 168, first LEI second flash 170, first REI second flash 172, first LEI third flash 174, first REI third flash 176, second LEI first flash 178, second REI first flash 180, second LEI second flash 182, second REI second flash 184, second LEI third flash 186, second REI third flash 188, third LEI first flash 190, third REI first flash 192, third LEI second flash 194, third REI second flash 196, third LEI third flash 198, and third REI third flash 200. Of course each flash is separated by a switching interval 126. While this triple flash system 164 further reduces flicker as compared to double flash system 138, not all conventional equipment is capable of accommodating the high speed switching between LEIs and REIs without reducing the overall resolution of the images

While there are many advanced methods of displaying 3D images, room for improvement with regard to reducing flicker remains.

### SUMMARY OF THE INVENTION

The present invention, in one embodiment is a method for displaying three dimensional images which comprises displaying a first image having a first polarization for one eye of a viewer, displaying a first image having a second polarization for the other eye of a viewer and alternately repeating these displaying steps until each of the displaying steps has been performed at least twice and until one of the displaying steps has been performed more times than the other of the displaying steps. The method can further comprise displaying a second image having the first polarization for the one eye of the viewer, displaying a second image having the second polarization for the other eye of the viewer, and alternately repeating the displaying steps for the second image until each of these displaying steps has been performed at least twice and until one of these displaying steps has been performed more times than the other of the displaying steps.

### BRIEF DESCRIPTION OF THE DRAWINGS

Prior Art FIG. 1 is a schematic illustration of conventional single, double, and triple flash systems according to the prior art;

FIG. 2 is a schematic illustration of a 3D projection system according to the present invention;

FIG. 3 is a schematic illustration of an alternating dominance non-integer timing scheme according to the present invention; and

FIG. 4 is a schematic illustration of a ready dominance non-integer timing scheme according to the present invention.

### DETAILED DESCRIPTION OF THE INVENTION

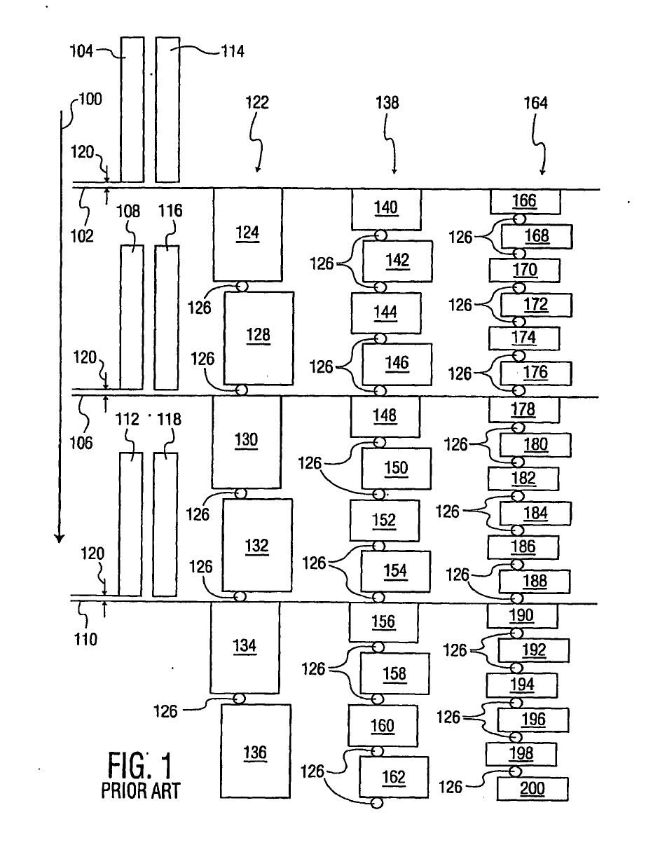

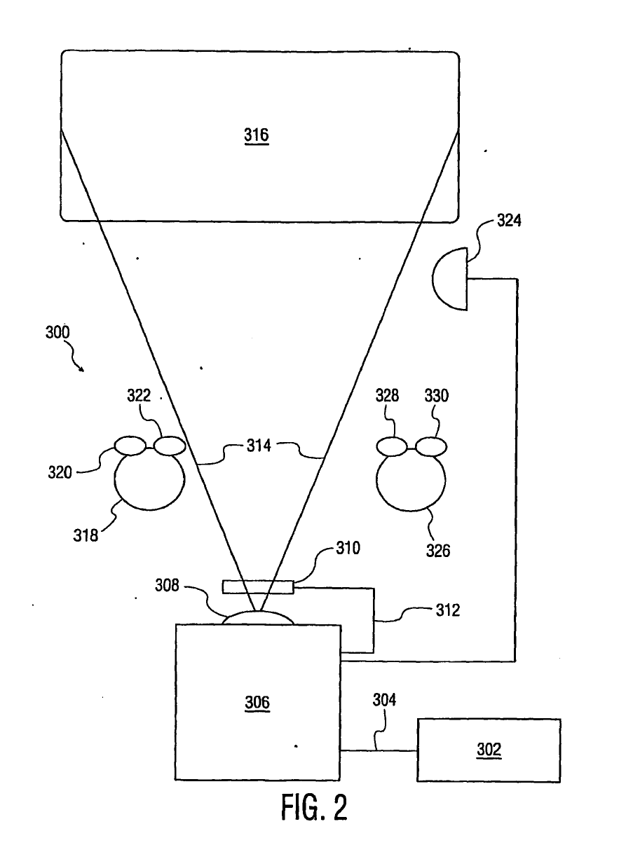

Referring now to FIG. 2 in the drawings, a 3D projection system according to the present invention is illustrated. 3D projection system 300 comprises an image source 302 (or image server) for providing LEIs and REIs over an image link 304 (which may be an encrypted, dual high definition serial digital interface (HD-SDI)) to a digital projector 306. The LEIs and REIs are projected from the projector 306 through a projection lens 308 and subsequently through a polarizing cell and driver 310 which is supplied a polarizing phase signal 312 from the projector 306. After passing through the polarizing cell and driver 310, the LEIs and REIs are directed as a projection 314 onto a screen 316. A viewer 318 is enabled to perceive the 3D image using a left eye polarized lens 320 and a right eye polarized lens 322. In operation, as a LEI is transmitted through the polarizing cell and driver 310, the LEI is polarized in a first polarization scheme. The polarized LEI is reflected from the screen 316 to the viewer 318 through left eye polarized lens 320. Similarly, as a REI is transmitted through the polarizing cell and driver 310, the REI is polarized in a second polarization scheme. The polarized REI is reflected from the screen 316 to the viewer 318 through right eye polarized lens 322. It will be appreciated that the polarization schemes may include the use of P-polarization/S-Polarization or clockwise circular polarization/counter-clockwise circular polarization. This embodiment requires that the screen 316 preserves the polarization of projection 314 as the projection in reflected from the screen 316 to the viewer 318.

In an alternative embodiment, the 3D projection system 300 may comprise an infrared emitter 324 for use with active shutter glasses worn by a user 326. The active shutter glasses comprise a left eye active shutter 328 and a right eye active shutter 330. The active shutter glasses include a receiver (not shown) for receiving a signal from the infrared emitter 324 (or transmitter). The signal provided to the active shutter glasses synchronizes the left and right eye active shutters 328 and 330 with the LEIs and REIs provided by the projector 306 so that the left eye active shutter 328 allows viewing when a LEI is displayed by the projector and so that the right eye active shutter 330 does not allow viewing when a LEI is displayed by the projector. Similarly, the right eye active shutter 330 allows viewing when a REI is displayed by the projector and the left eye active shutter 328 does not allow viewing when a REI is displayed by the projector 306. Of course, where an infrared emitter 324, left eye active shutter 328, and right eye active shutter 330 are used to allow viewing of a 3D image, the 3D projection system 300 would not need to employ the polarizing cell and driver 310, left eye polarized lens 320, or right eye polarized lens 322, nor would screen 316 be required to preserve polarization of projection 314.

Another alternative embodiment of 3D projection system 300 may comprise mutually exclusive narrow band RGB color comb filters for allowing only LEIs through a left color comb filter (not shown) and REIs through a right color comb filter (not shown). In this embodiment, the LEIs and REIs are projected from the projector 306 having color components suitable for filtering by the color comb filters.

Of course, the 3D projection system 300 is suitable for providing LEIs and REIs to the viewer's left and right eyes, respectively, at various rates and with various timing schemes (discussed infra).

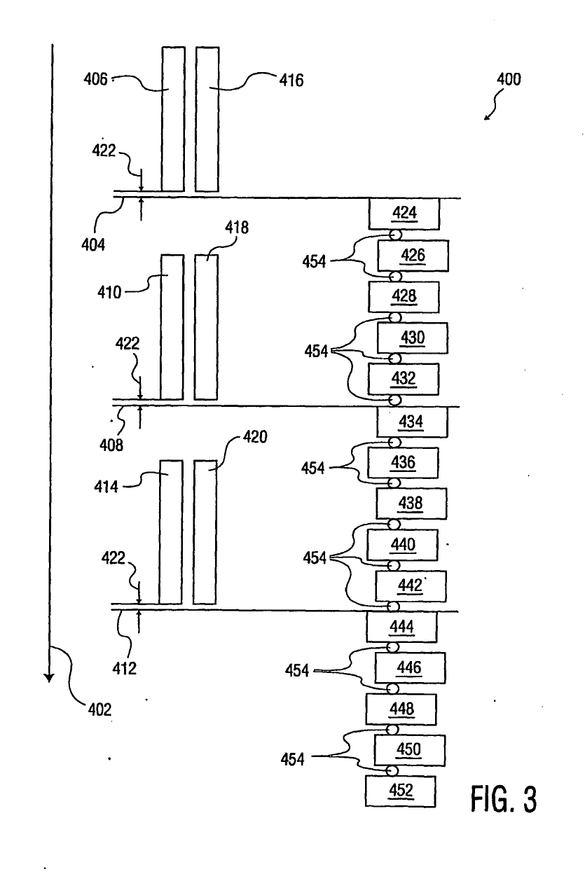

Referring now to FIG. 3 in the drawings, FIG. 3 illustrates an alternating dominance non-integer timing scheme 400 according to the present invention. Alternating dominance non-integer timing scheme 400 is suitable for use with 3D projection system 300 in providing LEIs and REIs to a viewer's left and right eyes, respectively. Arrow 402 indicates a direction in which time is represented as increasing. Horizontal line 404 represents a time at which a first LEI must be ready for projection to a viewer's left eye. LEITP 406 represents the timing and duration of transfer of the first LEI (or first left eye frame) from an image generator (or image server) to a projector. In this scheme for providing 3D images, delivery and availability for viewing of the LEIs and REIs are substantially synchronous such that they arrive to the projector from the generator and are available for projection at substantially the same time. This synchronized delivery is represented by first, second, and third REITPs 416, 418, and 420, respectively, having substantially synchronized start and completion times to the start and completion times of LEITPs 406, 410, and 414, respectively. The gaps in time between completion of delivery of the LEIs and the times at which LEIs must be ready for projection are generally referred to as slack in delivery 422 which typically correspond to the time occupied by the projector actually making the images viewable.

Still referring to FIG. 3, alternating dominance non-integer timing scheme 400, in this embodiment, alternates between LEIs and REIs 2.5 times before progressing to a second set of LEIs and REIs. The timing of this alternating dominance non-integer timing scheme 400 is represented by showing that a first LEI is flashed for a first LEI first duration 424 followed by a first REI that is flashed for a first REI first duration 426. Next, the first LEI is again flashed for a first LEI second duration 428 followed by the first REI again being flashed for a first REI second duration 430. Next, the first LEI is flashed for a first LEI third duration 432 which is not followed by any subsequent flashes of the first REI. Instead, the scheme 400 progresses to displaying a second set of LEIs and REIs.

Particularly, horizontal line 408 represents a time at which a second REI must be ready for viewing by a viewer's right eye and LEITP 410 represents the timing and duration of transfer of the second LEI. With this second set of LEIs and REIs, the RET is first to be displayed rather than the LEI. Specifically, a second REI is flashed for a second REI first duration 434 followed by a second LEI being flashed for a second LEI first duration 436. Next, the second REI is again flashed for a second REI second duration 438 followed by the second LEI again being flashed for a second LEI second duration 440. Next, the second REI is flashed for a second REI third duration 442 which is not followed by any subsequent flashes of the second LEI. Instead, the scheme 400 progresses to displaying a third set of LEIs and REIs.

Similarly, horizontal line 412 represents a time at which a third LEI must be ready for viewing by a viewer's left eye and LEITP 414 represents the timing and duration of transfer of the third LEI. As with the first set of LEIs and REIs, in this third set of LEIs and REIs, the LEI is first to be displayed rather than the REI. Finally, a third LEI is flashed for a third LEI first duration 444 followed by a third REI being flashed for a third REI first duration 446 followed by the third LEI again being flashed for a third LEI second duration 448. Next, the third REI is again flashed for a third REI second duration 450. Next, the third LEI is flashed for a third LEI third duration 452 which is not followed by any subsequent flashes of the third REI. Instead, the scheme 400 progresses to displaying a fourth and subsequent sets (not shown) of LEIs and REIs in this manner. A switching interval 454, a time during which no image is shown to either eye, occurs between each alternating display of LEIs and REIs and is useful in minimizing undesirable optical perception of crosstalk between the LEIs and REIs due to switching times of polarization cell and drivers 310 or shutters 328 and 330. The non-integer timing scheme provides for a decrease in perceived flicker by way of the increased number of times each LEI and REI are shown without exceeding bandwidth limitations of many conventional projectors. Since the bandwidth limitations of the equipment is not exceeded, the LEIs and REIs may be transmitted in their full resolution as intended by the producer of the image.

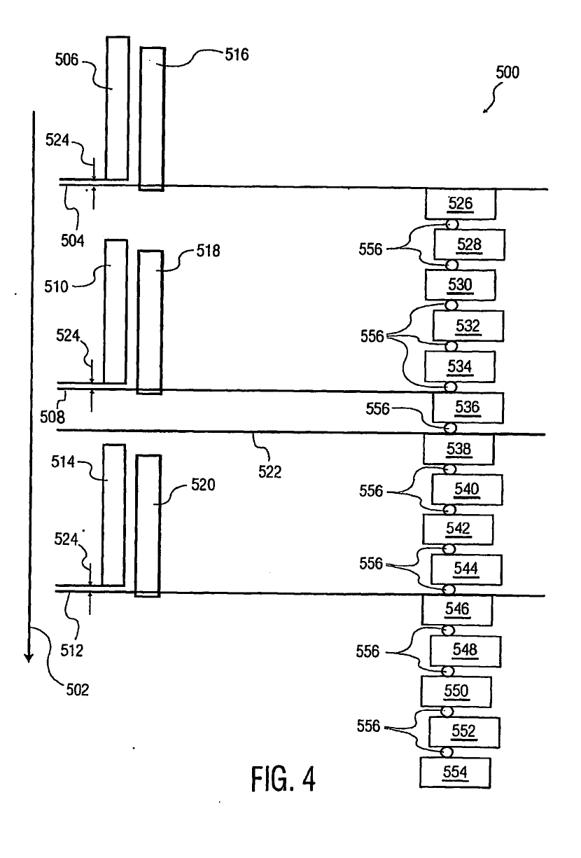

Referring now to FIG. 4 in the drawings, FIG. 4 illustrates a ready dominance non-integer timing scheme 500 according to the present invention. The ready dominance non-integer timing scheme 500 is suitable for use with 3D projection system 300 in providing LEIs and REIs to a viewer's left and right eyes, respectively. Arrow 502 indicates a direction in which time is represented as increasing. Horizontal line 504 represents a time at which a first LEI must be ready for projection to a viewer's left eye. LEITP 506 represents the timing and duration of transfer of the first LEI (or first left eye frame) from an image generator (or image server) to a projector. Horizontal line 508 represents a time at which a second LEI must be ready for viewing by a viewer's left eye and LEITP 510 represents the timing and duration of transfer of the second LEI. Similarly, horizontal line 512 represents a time at which a third LEI must be ready for viewing by a viewer's left eye and LEITP 514 represents the timing and duration of transfer of the third LEI. Unlike a conventional system for providing 3D images, delivery and availability for viewing of the LEIs and REIs are not synchronous such that they arrive to the projector from the generator and are available for projection at different times. This unsynchronized delivery is represented by first, second, and third REITPs 516, 518, and 520, respectively, having substantially offset start and completion times to the start and completion times of LEITPs 506, 510, and 514, respectively. However, it will be appreciated that in other alternative embodiments of the present invention, the unsynchronized delivery may be such that sets of LEIs and REIs are provided serially. The horizontal line 522 represents the time at which both the second LEI and REI are ready for viewing. The gaps in time between completion of delivery of the LEIs and the times at which LEIs must be ready for projection are generally referred to as slack in delivery 524 which typically correspond to the time occupied by the projector actually making the images viewable.

Still referring to FIG. 4, ready dominance non-integer timing scheme 500, in this embodiment, operates at a fixed rate of alternation between LEIs and REIs and proceeds to displaying successive LEIs and REIs when the LEIs and REIs are ready, even if a particular LEI or REI must be shown more or fewer times than previous LEIs or REIs. The timing of this ready dominance non-integer timing scheme 500 is represented by showing that a first LEI is flashed for a first LEI first duration 526 followed by a first REI that is flashed for a first REI first duration 528. Next, the first LEI is again flashed for a first LEI second duration 530 followed by the first REI again being flashed for a first REI second duration 532. Next, the first LEI is flashed for a first LEI third duration 534 followed by the first REI being flashed for a first REI third duration 536. Next, a second LEI is flashed for a second LEI first duration 538 followed by a second REI being flashed for a second REI first duration 540. Further, the second LEI is flashed for a second LEI second duration 542 followed by the second REI being flashed for a second REI second duration 544. Next, a third LEI is flashed for a third LEI first duration 546 followed by a third REI being flashed for a third REI first duration 548. Further, the third LEI is flashed for a third LEI second duration 550 followed by the third REI again being flashed for a third REI second duration 552. Finally, the third LEI is flashed for a third LEI third duration 554. A switching interval 556, a time during which no image is shown to either eye, occurs between each alternating display of LEIs and REIs and is useful in minimizing undesirable optical perception of crosstalk between the LEIs and REIs. The non-integer timing scheme provides for a decrease in perceived flicker without exceeding bandwidth limitations of many conventional projectors and/or polarization cells and drivers. Since the bandwidth limitations of the equipment is not exceeded, the LEIs and REIs may be transmitted in their full resolution as intended by the producer of the image.

A preferred embodiment of the invention can be characterized as a method of displaying a 3D image that comprises the steps of non-synchronously providing a first left eye image and a first right eye image for display; alternatingly displaying the first left eye image and the first right eye image at a substantially fixed rate, beginning with the first of first left eye image and the first right eye image to be fully provided; non-synchronously providing a second left eye image and a second right eye image for display; and substituting display of the first left eye image with the second left eye image when the second left eye image is fully provided and substituting display of the first right eye image with the second right eye image when the second right eye image is fully provided. In the method, the first left eye image is fully provided before the first right eye image or the first right eye image is fully provided before the first left eye image. The method can further be characterized in that the sum of the number of times the first left eye image is displayed and the number of times the first right eye image is displayed is not equal to the sum of the number of times the second left eye image is displayed and the number of times the second right eye image is displayed. Alternatively, the method can be characterized in that the first left eye image and the first right eye image are provided serially with respect to each other and the second left eye image and the second right eye image are provided serially and subsequent to the first left eye image and the first right eye image.

Another preferred embodiment of the invention can be characterized as a method of displaying three dimensional images that comprises: displaying a first image having a first polarization for one eye of a viewer; displaying a first image having a second polarization for the other eye of a viewer; and alternately repeating the displaying steps until one of the displaying steps has been performed more times than the other of the displaying steps The method can further comprise alternately repeating the displaying steps until each of the displaying steps has been performed at least twice.

The foregoing illustrates only some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

1. A method of displaying a 3D image, comprising the steps of:
providing a first left eye image and a first right eye image for display; and
alternatingly displaying the first left eye image and the first right eye image;
wherein the first left eye image and first right eye image are displayed an unequal number of times.

2. The method of displaying a 3D image according to claim 1, wherein the first left eye image is displayed first.

3. The method of displaying a 3D image according to claim 1, wherein the first right eye image is displayed first.

4. The method of displaying a 3D image according to claim 1, wherein the first left eye image and the first right eye image are provided substantially simultaneously.

5. The method of displaying a 3D image according to claim 1, further comprising the steps of:
providing a second left eye image and a second right eye image for display; and
after displaying the first left eye image and the first right eye image, alternatingly displaying the second left eye image and the second right eye image;
wherein the second left eye image and the second right eye image are displayed an unequal number of times.

6. The method of displaying a 3D image according to claim 5, wherein the first left eye image is displayed before the first right eye image and wherein the second right eye image is displayed before the second left eye image.

7. The method of displaying a 3D image according to claim 5, wherein the first right eye image is displayed before the first left eye image and wherein the second left eye image is displayed before the second right eye image.

8. The method of displaying a 3D image according to claim 5, wherein the first left eye image and the first right eye image are provided substantially simultaneously and wherein the second left eye image and the second right eye image are provided substantially simultaneously.

9. A method of displaying a 3D image, comprising the steps of non-synchronously providing a first left eye image and a first right eye image for display;
alternatingly displaying the first left eye image and the first right eye image at a substantially fixed rate, beginning with the first of first left eye image and the first right eye image to be fully provided;
non-synchronously providing a second left eye image and a second right eye image for display; and
substituting display of the first left eye image with the second left eye image when the second left eye image is fully provided and substituting display of the first right eye image with the second right eye image when the second right eye image is fully provided.

10. The method of displaying a 3D image according to claim 9, wherein the first left eye image is fully provided before the first right eye image.

11. The method of displaying a 3D image according to claim 9, wherein the first right eye image is fully provided before the first left eye image.

12. The method of displaying a 3D image according to claim 9, wherein the sum of the number of times the first left eye image is displayed and the number of times the first right eye image is displayed is not equal to the sum of the number of times the second left eye image is displayed and the number of times the second right eye image is displayed.

13. The method of displaying a 3D image according to claim 9, wherein the first left eye image and the first right eye image are provided serially with respect to each other, and wherein the second left eye image and the second right eye image are provided serially and subsequent to the first left eye image and the first right eye image.

14. A method for displaying three dimensional images, comprising the steps of
a.) displaying a first image having a first polarization for one eye of a viewer;
b.) displaying a first image having a second polarization for the other eye of a viewer; and,
c.) alternately repeating said displaying steps a.) and b.) until each of said displaying steps has been performed at least twice and until one of said displaying steps has been performed more times than the other of said displaying steps.

15. The method of claim 14, further comprising the steps of:
d.) displaying a second image having said first polarization for said one eye of said viewer;
e.) displaying a second image having said second polarization for said other eye of said viewer,
f.) alternately repeating said displaying steps d.) and e.) until each of said displaying steps d.) and e.) has been performed at least twice and until one of said displaying steps d.) and e.) has been performed more times than the other of said displaying steps d.) and e.).

16. A method for displaying three dimensional images, comprising the steps of
a.) displaying a first image having a first polarization for one eye of a viewer;
b.) displaying a first image having a second polarization for the other eye of a viewer; and,
c.) alternately repeating said displaying steps a.) and b.) until one of said displaying steps has been performed more times than the other of said displaying steps.

17. The method of claim 15, further comprising the step of:
d.) alternately repeating said displaying steps a.) and b.) until each of said displaying steps d.) and e.) has been performed at least twice.
